(19) United States
(12) Patent Application Publication
(10) Pub. No.: US 2016/0036089 A1
(43) Pub. Date: Feb. 4, 2016

(54) Heavy-Duty Hand-Held Power Tool

(71) Applicants: Manfred Lutz, Filderstadt (DE); Florian Esenwein, Leinfelden-Echterdingen (DE); Joern Stock, Bempflingen (DE); Joerg Maute, Sindelfingen (DE); Joachim Schadow, Stuttgart (DE); Daniel Barth, Leinfelden-Echterdingen (DE); Cornelius Boeck, Kirchheim (DE)

(72) Inventors: Manfred Lutz, Filderstadt (DE); Florian Esenwein, Leinfelden-Echterdingen (DE); Joern Stock, Bempflingen (DE); Joerg Maute, Sindelfingen (DE); Joachim Schadow, Stuttgart (DE); Daniel Barth, Leinfelden-Echterdingen (DE); Cornelius Boeck, Kirchheim (DE)

(21) Appl. No.: 14/815,128

(22) Filed: Jul. 31, 2015

(30) Foreign Application Priority Data
Jul. 31, 2014 (DE) 10 2014 215 045.0

(51) Int. Cl. H01M 10/052; B25F 5/00; H01M 12/08; B24B 23/02

(52) U.S. Cl. CPC H01M 10/052; B24B 23/028; B25F 5/00; H01M 12/08; H01M 2220/30

(57) ABSTRACT

A heavy-duty hand-held power tool appliance includes at least one electric motor configured to drive a working tool and an energy storage unit configured to supply electricity to the at least one electric motor.

This application claims priority under 35 U.S.C. §119 to patent application no. DE 10 2014 215 045.0, filed on Jul. 31, 2014 in Germany, the disclosure of which is incorporated herein by reference in its entirety.

### BACKGROUND

There has already been proposed a heavy-duty hand-held power tool appliance, having at least one electric motor, which is provided to drive a working tool. As is known, such heavy-duty hand-held power tools have an internal combustion engine or an electric motor for driving a working tool. Electric motors having a high output power are supplied with electrical energy from an external electric power supply network, in particular an alternating-voltage power supply network.

### SUMMARY

The disclosure is based on a heavy-duty hand-held power tool appliance, having at least one electric motor, which is provided to drive a working tool.

It is proposed that the heavy-duty hand-held power tool appliance comprise an energy storage unit, which is provided to supply electricity to the at least one electric motor. This enables the heavy-duty hand-held power tool appliance, advantageously, to be operated electrically and, at the same time, independently of an external electric power supply. In addition, the heavy-duty hand-held power tool appliance can have a low noise emission, while at the same time having a high output power. Applications that hitherto could only be performed by heavy-duty hand-held power tools operated by an internal combustion engine can now be performed, advantageously, by an electrically operated heavy-duty hand-held power tool appliance that is more environmentally benign. Advantageously, it is possible to dispense with an external electric power supply network, in particular an alternating-voltage power supply network. The energy storage unit preferably constitutes a storage battery. Advantageously, the storage battery has a plurality of storage-battery cells. A “heavy-duty hand-held power tool” is to be understood to mean, in particular, a portable machine for performing work on a workpiece, having an output power of more than 1000 W. Advantageously, the heavy-duty hand-held power tool appliance constitutes an angle grinder, a cut-off grinder, a hammer drill, a chain saw, a core-hole drill and/or a router. Preferably, the heavy-duty hand-held power tool appliance has an overall efficiency of at least 75%. “Provided” is to be understood to mean, in particular, specially programmed, designed and/or equipped. That an object is provided for a particular function is to be understood to mean, in particular, that the object fulfils and/or executes this particular function in at least one application state and/or operating state.

In a further design of the disclosure, it is proposed that the energy storage unit have at least one lithium-air cell. This makes it possible to achieve a particularly long battery operating time with, at the same time, a high output power. Advantageously, the energy storage unit may have a mass-energy density of up to 11.14 kWh/kg. The at least one lithium-air cell preferably has at least one positive electrode of mesoporous carbon.

In addition, it is proposed that the energy storage unit have at least one lithium-sulfur cell. This makes it possible to achieve a particularly long battery operating time with, at the same time, a high output power. Advantageously, the energy storage unit may have a mass-energy density of up to 2.6 kWh/kg.

Furthermore, it is proposed that the at least one electric motor have an output power of at least 1400 W. This enables a particularly broad spectrum of applications to be covered. Preferably, the at least one electric motor has an output power of at least 1700 W, particularly preferably of at least 2000 W, quite particularly preferably of at least 2500 W.

Moreover, it is proposed that the energy storage unit have a mass-energy density of at least 350 Wh/kg. This enables a particularly large quantity of energy to be stored, but with the energy storage unit having a low weight.

In addition, it is proposed that the energy storage unit have a volume-energy density of at least 700 Wh/l. This enables a particularly large quantity of energy to be stored, but with the energy storage unit having a small volume.

Furthermore, it is proposed that the energy storage unit have an energy quantity of at least 270 Wh. This enables a particularly long operating period to be achieved, with a high output power. Preferably, the energy storage unit has an energy quantity of at least 350 Wh, preferably of at least 500 Wh, and quite particularly preferably of at least 750 Wh.

In a further design of the disclosure, it is proposed that the heavy-duty hand-held power tool appliance have a total weight of less than 5.5 kg. This enables the heavy-duty hand-held power tool appliance to be designed, advantageously, so as to be easy to operate and transport. Particularly advantageously, the heavy-duty hand-held power tool appliance has a total weight of less than 4.5 kg, particularly advantageously of less than 3.5 kg.

A particularly advantageous design of the disclosure may be achieved if the heavy-duty hand-held power tool appliance has an angle-grinding unit, which comprises a tool carrier shaft that, in at least one operating state, is connected in a rotationally fixed manner to a working tool. Advantageously, this enables the heavy-duty hand-held power tool appliance to be used for cutting-off and/or grinding workpieces.

In addition, an energy storage unit of a heavy-duty hand-held power tool appliance is proposed.

The heavy-duty hand-held power tool appliance according to the disclosure in this case is not intended to be limited to the application and embodiment described above. In particular, the heavy-duty hand-held power tool appliance according to the disclosure may have individual elements, components and units that differ in number from a number stated herein, for the purpose of fulfilling a functionality described herein.

### BRIEF DESCRIPTION OF THE DRAWINGS

Further advantages are given by the following description of the drawing. Two exemplary embodiments of the drawing are represented in the drawing. The drawing, the description and the claims contain numerous features in combination. Persons skilled in the art will expediently also consider the features individually and combine them to form further appropriate combinations.

In the Drawings:

FIG. 1 shows a heavy-duty hand-held power tool appliance according to the disclosure, in a partial section, and

FIG. 2 shows a further exemplary embodiment of a heavy-duty hand-held power tool appliance, in a partial section.

### DETAILED DESCRIPTION

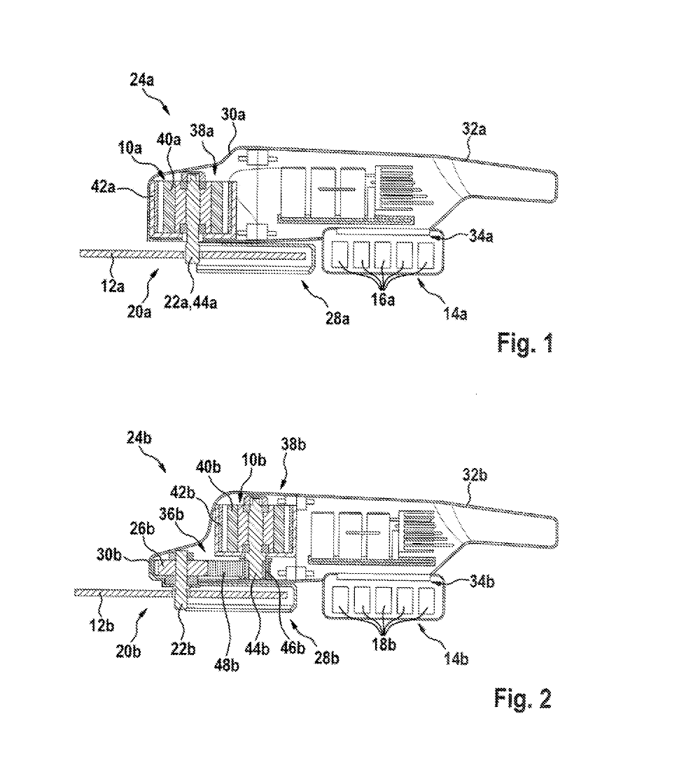

A first exemplary embodiment of a heavy-duty hand-held power tool appliance is shown in FIG. 1. The heavy-duty hand-held power tool appliance constitutes a portable power tool 24a. More precisely, the heavy-duty hand-held power tool appliance constitutes a portable angle grinder. The heavy-duty hand-held power tool appliance in this case has a total weight of less than 4.5 kg. An output power of the heavy-duty hand-held power tool appliance is 1700 watts.

The portable power tool 24a comprises a motor housing 30a, on which a basic housing 32a of the heavy-duty hand-held power tool appliance can be disposed, and a protective cover unit 28a that can be disposed on the motor housing 30a. The basic housing 32a in this case constitutes a main handle. The heavy-duty hand-held power tool appliance may have further elements, considered appropriate by persons skilled in the art. The elements may realize operating elements, in particular mode switches (for example, for an eco mode and/or a boost mode), operating elements and/or a speed adjusting handwheel. Furthermore, the elements may be provided for illumination and realize, for example, LED rings and/or light guides. Likewise, the elements may be provided for passive and/or active cooling. In this case, the elements may realize, for example, cooling fins and/or fans. Likewise, the elements may realize a radio interface. Furthermore, the elements may realize a display, in particular an LCD display, an OLED display and/or an LED display.

The heavy-duty hand-held power tool appliance additionally has an electric motor 10a, which is provided to drive a working tool 12a. The electric motor 10a is part of a drive unit 38a of the heavy-duty hand-held power tool appliance. The electric motor 10a is realized as an external-rotor motor. The electric motor 10a in this case has a stationary stator 40a on the inside. The stator 40a is surrounded by a rotatable rotor 42a. The rotor 42a is connected in a rotationally fixed manner to a rotor shaft 44a of the drive unit 38a. The heavy-duty hand-held power tool appliance has an angle grinding unit 20a, which comprises a tool carrier shaft 22a. In this exemplary embodiment, the rotor shaft 44a is realized so as to be integral with the tool carrier shaft 22a. The heavy-duty hand-held power tool appliance thus has a direct drive unit. For the purpose of connecting to the working tool 12a for performing work on a workpiece (not represented in greater detail here), the tool carrier shaft 22a extends out of the motor housing 30a.

The working tool 12a is realized as a cutting disk, which can be fixed to the tool carrier shaft 22a in a manner already known to persons skilled in the art. It is also conceivable, however, for the working tool 12a to be realized as a grinding or polishing disk. The tool carrier shaft 22a is connected in a rotationally fixed manner to the working tool 12a. The working tool 12a is realized so as to be detachable from the tool carrier shaft 22a, in a manner known to persons skilled in the art.

Furthermore, the portable power tool 24a has an energy supply coupling unit 34a. In this case, the energy supply coupling unit 34a is realized as a storage-battery interface. The heavy-duty hand-held power tool appliance comprises an energy storage unit 14a, which is provided to supply electrical energy to the electric motor 10a. The energy storage unit 14a constitutes a storage battery. The energy storage unit 14a can be coupled to an energy supply coupling unit 34a. The portable power tool 24a is thus realized such that it can be operated by storage battery, in at least one operating state.

The energy storage unit 14a has a multiplicity of lithium-air cells 16a. It is also conceivable, in relation to this, for the energy storage unit 14a to have only one lithium-air cell 16a. Preferably, at least some lithium-air cells 16a are connected to each other in a series connection. The energy storage unit 14a advantageously has a nominal voltage of between 15 V and 21 V, and a charge capacity of at least 18 Ah. Alternatively, the energy storage unit 14a advantageously has a nominal voltage of between 30 V and 58 V, and a charge capacity of at least 12 Ah. The energy storage unit 14a has a mass-energy density of more than 3000 Wh/kg. The energy storage unit 14a in this case has a volume-energy density of more than 1500 Wh/l. The energy storage unit 14a additionally has a power density of more than 1800 Wh/kg. The energy storage unit 14a in this case has an energy quantity of more than 700 Wh. The electric motor 10a has an output power of 1700 W. An operating time of the electric motor 10a at maximum output power is more than 20 minutes. A rotational speed of the working tool 12a in this case is between 5500 revolutions per minute and 12000 revolutions per minute. The heavy-duty hand-held power tool appliance has an overall efficiency of at least 75%.

The lithium-air cells 16a each have a positive electrode of mesoporous carbon. The lithium-air cells 16a each have a negative electrode of metallic lithium. When the lithium-air cells 16a are being discharged, positive lithium ions are given off at the negative electrodes by the discharge of electrons, to the positive electrode, via an electrolyte. The lithium ions are oxidized with oxygen, first to form lithium oxide and subsequently to form lithium peroxide. When the energy storage unit 14a is being charged, oxygen is given off at the positive electrode. At the negative electrode, metallic lithium is precipitated. The positive electrode does not directly participate in the electrochemical process. The carbon constitutes an electrical conductor and connector. The mesoporous structure is provided to maximize a surface area, in order to improve a reaction of the lithium ions with oxygen in the region of the positive electrode. Between the two electrodes there is an electrolyte, which may be in liquid form, or may also be solid, depending on the embodiment.

A further exemplary embodiment of the disclosure is shown in FIG. 2. The description that follows and the drawing are limited substantially to the differences between the exemplary embodiments, and in principle, in respect of components of like designation, in particular in relation to components having the same references, reference may also be made to the drawing and/or the description of the other exemplary embodiment. To differentiate the exemplary embodiments, the letter a has been appended to the references of the exemplary embodiment in FIG. 1. In the exemplary embodiment of FIG. 2, the reference a has been replaced by the letter b.

A second exemplary embodiment of the heavy-duty hand-held power tool appliance is shown in FIG. 2. The heavy-duty hand-held power tool appliance constitutes a portable power tool 24b. More precisely, the heavy-duty hand-held power tool appliance constitutes a portable angle grinder. The heavy-duty hand-held power tool appliance in this case has a total weight of less than 5.5 kg. An output power of the heavy-duty hand-held power tool appliance is 1400 watts. The portable power tool 24b comprises a motor housing 30b, on which a basic housing 32b of the heavy-duty hand-held power tool appliance can be disposed, and a protective cover unit 28b that can be disposed on the motor housing 30b. The basic housing 32b in this case constitutes a main handle.

The heavy-duty hand-held power tool appliance additionally has an electric motor 10b, which is provided to drive a working tool 12b. The electric motor 10b is part of a drive unit 38b of the heavy-duty hand-held power tool appliance. The electric motor 10b is realized as an external-rotor motor. The electric motor 10b in this case has a stationary stator 40b on the inside. The stator 40b is surrounded by a rotatable rotor 42b. The rotor 42b is connected in a rotationally fixed manner to a rotor shaft 44b of the drive unit 38b. The heavy-duty hand-held power tool appliance has an angle grinding unit 20b, which comprises a tool carrier shaft 22b.

In this exemplary embodiment, the heavy-duty hand-held power tool appliance comprises a transmission unit 36b. The transmission unit 36b constitutes a belt transmission. More precisely, the transmission unit 36b constitutes a toothed belt transmission. The rotor shaft 44b is connected in a rotationally fixed manner to a drive pulley 46b of the transmission unit 36b. A toothed belt 48b of the transmission unit 36b transmits a driving force to an output pulley 26b. The output pulley 26b is connected in a rotationally fixed manner to the tool carrier shaft 22b. In this exemplary embodiment, the tool carrier shaft 22b is disposed with an axial offset in relation to the rotor shaft 44b.

The working tool 12b is realized as a cutting disk, which can be fixed to the tool carrier shaft 22b in a manner already known to persons skilled in the art. It is also conceivable, however, for the working tool 12b to be realized as a grinding or polishing disk. The tool carrier shaft 22b is connected in a rotationally fixed manner to the working tool 12b. The working tool 12b is realized so as to be detachable from the tool carrier shaft 22b, in a manner known to persons skilled in the art.

Furthermore, the portable power tool 24b has an energy supply coupling unit 34b. In this case, the energy supply coupling unit 34b is realized as a storage-battery interface. The heavy-duty hand-held power tool appliance comprises an energy storage unit 14b, which is provided to supply electrical energy to the electric motor 10b. The energy storage unit 14b constitutes a storage battery. The energy storage unit 14b can be coupled to the energy supply coupling unit 34b. The portable power tool 24b is thus realized such that it can be operated by storage battery, in at least one operating state.

The energy storage unit 14b has a multiplicity of lithium-sulfur cells 18b. It is also conceivable, in relation to this, for the energy storage unit 14b to have only one lithium-sulfur cell 18b. Preferably, at least some lithium-sulfur cells 18b are connected to each other in a series connection. The energy storage unit 14b advantageously has a nominal voltage of between 15 V and 21 V, and a charge capacity of at least 18 Ah. Alternatively, the energy storage unit 14b advantageously has a nominal voltage of between 30 V and 58 V, and a charge capacity of at least 12 Ah. The energy storage unit 14b has a mass-energy density of more than 350 Wh/kg. The energy storage unit 14b in this case has a volume-energy density of more than 600 Wh/l. The energy storage unit 14b additionally has a power density of more than 1800 Wh/kg. The energy storage unit 14b in this case has an energy quantity of more than 300 Wh. The electric motor 10b has an output power of 1400 W. An operating time of the electric motor 10b at maximum output power is more than 12 minutes. The heavy-duty hand-held power tool appliance has an overall efficiency of at least 75%.

The lithium-sulfur cells 18b each have a positive electrode of sulfur as a composite with carbon. In addition, the lithium-sulfur cells 18b each have a negative electrode of metallic lithium. During discharging, lithium is dissolved at the positive electrode. At the negative electrode, the lithium combines with sulfur to form lithium sulfide. During the charging operation, the lithium sulfide is again dissolved, and sulfur is formed. At the negative electrode, in this case, metallic lithium is again deposited.

What is claimed is:

1. A heavy-duty hand-held power tool appliance, comprising:
at least one electric motor configured to drive a working tool; and
an energy storage unit configured to supply electricity to the at least one electric motor.

2. The heavy-duty hand-held power tool appliance according to claim 1, wherein the energy storage unit includes at least one lithium-air cell.

3. The heavy-duty hand-held power tool appliance according to claim 1, wherein the energy storage unit includes at least one lithium-sulfur cell.

4. The heavy-duty hand-held power tool appliance according to claim 1, wherein the at least one electric motor has an output power of at least 1,400 W.

5. The heavy-duty hand-held power tool appliance according to claim 1, wherein the energy storage unit has a mass-energy density of at least 350 Wh/kg.

6. The heavy-duty hand-held power tool appliance according to claim 1, wherein the energy storage unit has a volume-energy density of at least 700 Wh/l.

7. The heavy-duty hand-held power tool appliance according to claim 1, wherein the energy storage unit has an energy quantity of at least 270 Wh.

8. The heavy-duty hand-held power tool appliance according to claim 1, wherein the heavy-duty hand-held power tool appliance has a total weight of less than 5.5 kg.

9. The heavy-duty hand-held power tool appliance according to claim 1, further comprising an angle-grinding unit that includes a tool carrier shaft that, in at least one operating state, is configured to be connected in a rotationally fixed manner to the working tool.

10. An energy storage unit of a heavy-duty hand-held power tool appliance, wherein the energy storage unit is configured to supply electrical energy to at least one electric motor of the heavy-duty hand-help power tool applicant which is configured to drive a working tool.
